(19) United States
(12) Patent Application Publication
(10) Pub. No.: US 2010/0053113 A1
(43) Pub. Date: Mar. 4, 2010

(54) Electromagnetic Stylus for Operating a Capacitive Touch Panel

(76) Inventors: Cheng-Ko Wu, Taoyuan County (TW); Ming-Tsung Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/327,813

(22) Filed: Dec. 4, 2008

(30) Foreign Application Priority Data
Sep. 1, 2008 (TW) 097133438

(51) Int. Cl. G06F 3/033

(52) U.S. Cl. 345/174

(57) ABSTRACT

When a user moves an electromagnetic stylus to a capacitive touch panel, a transceiving winding will detect the frequency of the capacitive touch panel. A synchronizing winding will oscillate to generate a signal having a frequency similar to that of the capacitive touch panel. An oscillator will amplify the signal generated by the synchronizing winding. A circuit board will process the signal amplified by the oscillator. Finally the transceiving winding will emit a wireless signal with a frequency similar to that of the capacitive touch panel to interfere with the electric (magnetic) field of the capacitive touch panel so as to detect a triggered coordinate of the capacitive touch panel.

### BACKGROUND OF THE INVENTION

1. Field of the Invention

The present invention provides an electromagnetic stylus, and more particularly, an electromagnetic stylus for controlling a capacitive touch panel.

2. Description of the Prior Art

There are three typical types of prior art touch panels. The first is a resistive type. A coordinate of a resistive type touch panel is determined by pressing on the area of the touch panel to enable the contact of two electrodes. The second is a capacitive type. After a stylus triggers an area of a capacitive type touch panel, a leakage of current will flow from the contact area to fingers holding the stylus through the tip and conductors of the stylus, thus a coordinate corresponding to the area of the capacitive type touch panel can be determined. If the fingers holding the stylus are wearing a glove or other insulation materials, then the triggered coordinate of the capacitive type touch panel cannot be determined because no leakage current can pass through the fingers to ground. The third type utilizes an electromagnetic stylus with a digitizer. The electromagnetic stylus emits signals to the digitizer or the digitizer senses the electromagnetic stylus to detect a triggered coordinate of the digitizer. However, the electromagnetic stylus has to be used with the digitizer.

Please refer to FIGS. 1 and 2. FIG. 1 is a perspective view of a prior art capacitive touch panel 10. FIG. 2 is a top view of the capacitive touch panel 10. The capacitive touch panel 10 comprises a first conductive layer 12, an insulation layer 14 and an anti-electronic jamming layer 16. When voltage is imposed on the first conductive layer 12, the surface of the conductive layer will generate a uniform electric (electromagnetic) field 26. The anti-electronic jamming layer 16 can prevent the interference of external electronic signals. When a capacitive stylus touches the capacitive touch panel 10, a current will leak from the stylus to a human body, and instantaneously change the electric (electromagnetic) field 26 so that the leakage current of the capacitive touch panel 10 is changed. Then the capacitive touch panel 10 can determine the coordinate of the triggered position of the touch panel 10 according to the variation of the leakage current.

However in many laboratories, experimental staffs may wear gloves or other insulated clothing to prevent accidents. In this case, if an experimental staff uses a capacitive stylus to trigger the capacitive touch panel 10, then the leakage current cannot flow towards the human body through the stylus. Thus the electric (electromagnetic) field would not be changed, and the capacitive touch panel 10 cannot determine the triggered coordinate of the capacitive touch panel 10 according to the change of the electric (electromagnetic) field.

### SUMMARY OF THE INVENTION

An embodiment of the present invention provides an electromagnetic stylus for controlling a capacitive touch panel. The electromagnetic stylus comprises a housing, a signal transducer for accessing a frequency signal of the capacitive touch panel, a transceiving winding encircling the signal transducer for receiving and transmitting wireless signals having a frequency similar to a frequency of the capacitive touch panel, a synchronizing winding encircling the signal transducer for generating a frequency signal having a frequency similar to the frequency of the capacitive touch panel through oscillation, an oscillator for amplifying the frequency signal generated by the synchronizing winding, and a circuit board installed inside the housing and connected to the signal transducer for processing the frequency signal amplified by the oscillator.

Another embodiment of the present invention provides an electromagnetic stylus for controlling a capacitive touch panel. The electromagnetic stylus comprises a housing, a signal transducer for accessing a frequency signal of the capacitive touch panel, a transceiving winding encircling the signal transducer for receiving and transmitting wireless signals having a frequency similar to a frequency of the capacitive touch panel, a synchronizing winding encircling the signal transducer for generating a frequency signal having a frequency similar to the frequency of the capacitive touch panel through oscillation, a controller for amplifying the frequency signal generated by the synchronizing winding, and a circuit board installed inside the housing and connected to the signal transducer for processing the frequency signal amplified by the controller.

Another embodiment of the present invention provides an electromagnetic stylus for controlling a capacitive touch panel. The electromagnetic stylus comprises a housing, a signal transducer for accessing a frequency signal of the capacitive touch panel, a transceiving winding encircling the signal transducer for receiving and transmitting wireless signals having a frequency similar to a frequency of the capacitive touch panel, a controller for generating a frequency signal having a frequency similar to the frequency of the capacitive touch panel according to the wireless signals received by the transceiving winding, and a circuit board installed inside the housing and connected to the signal transducer for processing the frequency signal generated by the controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a prior art capacitive touch panel.

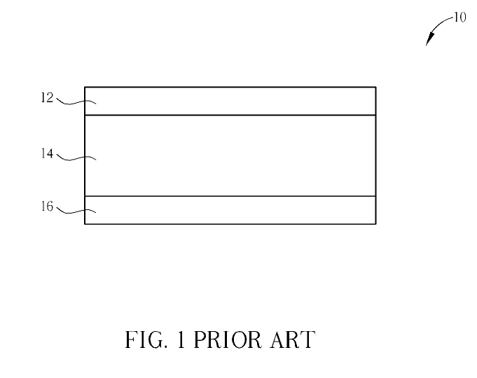

FIG. 2 is a top view of the capacitive touch panel in FIG. 1.

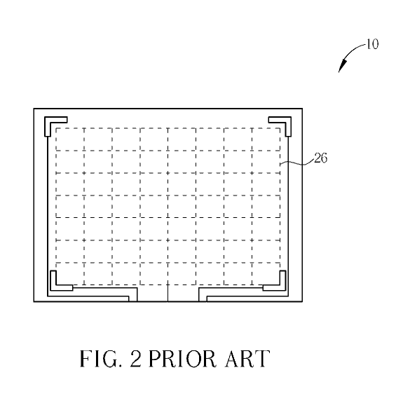

FIG. 3 is a perspective view of an electromagnetic stylus according to the first embodiment of the present invention.

FIG. 4 is a perspective view of an electromagnetic stylus according to the second embodiment of the present invention.

FIG. 5 is a perspective view of an electromagnetic stylus according to the third embodiment of the present invention.

### DETAILED DESCRIPTION

In order to solve the problem of being unable to determine the triggered coordinate of the capacitive touch panel 10 when a user wears an insulation material, the present invention provides an electromagnetic stylus so that the user can use the electromagnetic stylus to control the capacitive touch panel 10 regardless of whether the user wears an insulation material or not.

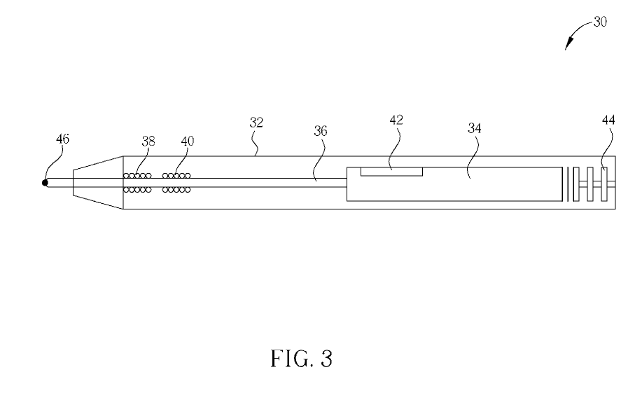

Please refer to FIG. 3. FIG. 3 is a perspective view of an electromagnetic stylus 30 according to the first embodiment of the present invention. The electromagnetic stylus 30 comprises a housing 32, a signal transducer 36 for accessing a frequency signal of the capacitive touch panel 10, a transceiving winding 38 encircling the signal transducer 36 for detecting the frequency of the capacitive touch panel 10 and transmitting wireless signals having a frequency similar to the frequency of the capacitive touch panel 10, a synchronizing winding 40 encircling the signal transducer 36 for generating a frequency signal having a frequency similar to the frequency of the capacitive touch panel 10 through oscillation, an oscillator 42 for amplifying the frequency signal generated by the synchronizing winding 40, a circuit board 34 installed inside the housing 32 and connected to the signal transducer 36 for processing the frequency signal amplified by the oscillator 42, and a battery 44 installed inside the housing 32 for providing power to the electromagnetic stylus 30. The oscillator 42 can be installed on the circuit board 34. And the oscillator 42 can be implemented by active elements, passive elements, or a combination of active elements and passive elements.

When a user moves the electromagnetic stylus 30 to a position above the capacitive touch panel 10, the transceiving winding 38 will detect the frequency of the electric (electromagnetic) field of the capacitive touch panel 10. The synchronizing winding 40 will generate a signal having a frequency similar to the frequency of the signal flowing from the capacitive touch panel 10 to the signal transducer 36 through oscillation. The oscillator 42 will amplify the frequency signal generated by the synchronizing winding 40. The circuit board 34 will process the signal amplified by the oscillator 42. And the transceiving winding 38 will transmit wireless signals having a frequency similar to that of the capacitive touch panel 10 to interfere with the electric (electromagnetic) field of the capacitive touch panel 10.

When the capacitive touch panel 10 receives the wireless signals transmitted by the transceiving winding 38, regardless of whether the phase of the wireless signals transmitted by the transceiving winding 38 is the same as the phase of the capacitive touch panel 10 or not, the electric (electromagnetic) field at the surface of the capacitive touch panel 10 is interfered. Thus the triggered coordinate of the capacitive touch panel 10 can be determined according to the change of the electric (electromagnetic) field.

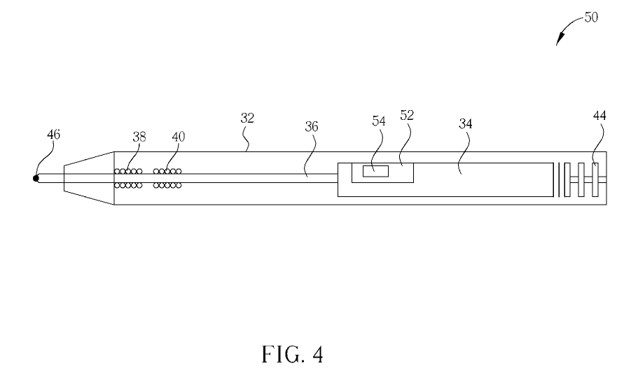

Please refer to FIG. 4. FIG. 4 is a perspective view of an electromagnetic stylus 50 according to the second embodiment of the present invention. The difference between the electromagnetic stylus 50 and the electromagnetic stylus 30 is that the oscillator 42 in FIG. 3 is replaced with a controller 52 in FIG. 4. The controller 52 uses firmware or software to amplify the frequency signal generated by the synchronizing winding 40. The controller 52 may comprise an amplifier 54 to further amplify the frequency signal to ensure that the circuit board 34 can process the frequency signal amplified by the controller 52.

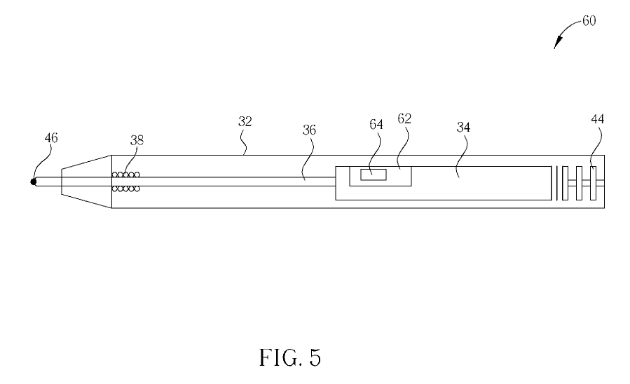

Please refer to FIG. 5. FIG. 5 is a perspective view of an electromagnetic stylus 60 according to the third embodiment of the present invention. The difference between the electromagnetic stylus 60 and the electromagnetic stylus 50 is that the electromagnetic stylus 60 does not have a synchronizing winding 40. After the electromagnetic stylus 60 is reset, when the electromagnetic stylus 60 contacts the capacitive touch panel 10 for the first time, the controller 62 uses either firmware or software to sample the wireless signals received by the transceiving winding 38, and generate a frequency signal with a frequency similar to that of the capacitive touch panel 10 according to the sampled data. The controller 62 can comprise an amplifier 64 to amplify the frequency signal to ensure that the circuit board 34 can process the frequency signal amplified by the controller 62. After the controller 62 generates the frequency signal, the electromagnetic stylus 60 can operate according to the frequency signal generated by the controller 62. The controller 62 does not need to generate another frequency signal so long as the electromagnetic stylus 60 is not reset. The electromagnetic stylus 60 is reset when the electromagnetic stylus 60 does not trigger the capacitive touch panel 10 for a certain period of time (such as 5 seconds or another length of time).

Compared to the prior art capacitive stylus, the electromagnetic stylus 30, 50, 60 emits wireless signals with a frequency similar to that of the capacitive touch panel 10 to interfere with the electric (electromagnetic) field of the capacitive touch panel 10. Thus even if a user wears a glove or another insulation material, the capacitive touch panel 10 can still determine the triggered coordinate of the capacitive touch panel 10 according to the change of the electric (electromagnetic) field of the capacitive touch panel 10.

Those skilled in the art will readily observe that numerous modifications and alterations of the device and method may be made while retaining the teachings of the invention.

What is claimed is:

1. An electromagnetic stylus for controlling a capacitive touch panel comprising:
a housing;
a signal transducer for accessing a frequency signal of the capacitive touch panel;
a transceiving winding encircling the signal transducer for receiving and transmitting wireless signals having a frequency similar to a frequency of the capacitive touch panel;
a synchronizing winding encircling the signal transducer for generating a frequency signal having a frequency similar to the frequency of the capacitive touch panel through oscillation;
an oscillator for amplifying the frequency signal generated by the synchronizing winding; and
a circuit board installed inside the housing and connected to the signal transducer for processing the frequency signal amplified by the oscillator.

2. The electromagnetic stylus of claim 1 wherein the oscillator is installed on the circuit board.

3. The electromagnetic stylus of claim 1 further comprising a battery installed inside the housing for providing power to the electromagnetic stylus.

4. An electromagnetic stylus for controlling a capacitive touch panel comprising:
a housing;
a signal transducer for accessing a frequency signal of the capacitive touch panel;
a transceiving winding encircling the signal transducer for receiving and transmitting wireless signals having a frequency similar to a frequency of the capacitive touch panel;
a synchronizing winding encircling the signal transducer for generating a frequency signal having a frequency similar to the frequency of the capacitive touch panel through oscillation;
a controller for amplifying the frequency signal generated by the synchronizing winding; and
a circuit board installed inside the housing and connected to the signal transducer for processing the frequency signal amplified by the controller.

5. The electromagnetic stylus of claim 4 wherein the controller is installed on the circuit board.

6. The electromagnetic stylus of claim 4 wherein the controller comprises an amplifier for amplifying the frequency signal generated by the synchronizing winding.

7. The electromagnetic stylus of claim 4 further comprising a battery installed inside the housing for providing power to the electromagnetic stylus.

8. An electromagnetic stylus for controlling a capacitive touch panel comprising:
a housing;
a signal transducer for accessing a frequency signal of the capacitive touch panel;
a transceiving winding encircling the signal transducer for receiving and transmitting wireless signals having a frequency similar to a frequency of the capacitive touch panel;
a controller for generating a frequency signal having a frequency similar to the frequency of the capacitive touch panel according to the wireless signals received by the transceiving winding; and
a circuit board installed inside the housing and connected to the signal transducer for processing the frequency signal generated by the controller.

9. The electromagnetic stylus of claim 8 wherein the controller is installed on the circuit board.

10. The electromagnetic stylus of claim 8 wherein the controller comprises an amplifier for amplifying the frequency signal generated by the controller.

11. The electromagnetic stylus of claim 8 further comprising a battery installed inside the housing for providing power to the electromagnetic stylus.
